(19) United States
(12) Patent Application Publication
(10) Pub. No.: US 2009/0122015 A1
(43) Pub. Date: May 14, 2009

(54) MOBILE TERMINALS HAVING A MOVABLE KEYBOARD AND METHODS FOR OPERATING THE SAME

(76) Inventor: Randolph Cary Demuynck, Wake Forest, NC (US)

Correspondence Address: MYERS BIGEL SIBLEY & SAJOVEC, PO BOX 37428, RALEIGH, NC, 27627, US

(21) Appl. No.: 11/939,057

(22) Filed: Nov. 13, 2007

(51) Int. Cl. G06F 3/02

(52) U.S. Cl. 345/169

(57) ABSTRACT

Mobile terminals are provided including a portable housing. A display is rotatably coupled to the portable housing for movement between a closed position proximate the housing to an open position extending from the housing. A keypad moveably coupled to the portable housing. A coupling mechanism couples to the display and to the keypad and translates rotational movement of the display between the open and closed position to a selected displacement of the keypad.

### BACKGROUND OF THE INVENTION

The present invention relates to the field of communications, and, more particularly, to mobile terminals.

The size of wireless terminals has been decreasing with many contemporary wireless mobile terminals being less than 11 centimeters in length. Mobile terminals may be referred to as being either a bar or clam shell (or flip) style mobile terminal. A clam shell differs from a bar in that it generally includes a display member (flip). The flip is typically rotatably coupled to an end of the mobile terminal and is rotated to an open position to expose a keypad and extend the length of the mobile terminal. As a result of the decreasing size of mobile terminals, the extended length in the opened position may make the terminal easier for a user to operate. In addition, some flip style mobile terminals are provided with a spring arrangement allowing pressing of a button to automatically rotate the flip for a user.

### SUMMARY OF THE INVENTION

Some embodiments of the present invention provide mobile terminals including a portable housing. A display is rotatably coupled to the portable housing for movement between a closed position proximate the housing to an open position extending from the housing. A keypad moveably coupled to the portable housing. A coupling mechanism couples to the display and to the keypad and translates rotational movement of the display between the open and closed position to a selected displacement of the keypad.

In other embodiments, the selected displacement is a selected linear movement and the coupling mechanism includes a keypad drive member coupled to the keypad and a gear assembly coupling the keypad drive member to the display that translates rotational movement of the display to the selected linear movement of the keypad. The display may be rotatably coupled to the housing about a rotational axis extending across a width of the housing and rotation of the display to the open position may extend the display toward the first end and extends the keypad toward the second end. The rotational axis may extend across the width of the housing at a longitudinal position located between and displaced from respective longitudinally displaced first and second ends of the housing.

In further embodiments, a wireless communication circuit may be provided in the housing and the housing may be a handheld housing. When the display is in the open position, the keypad, housing and display define a curved front face of the mobile terminal generally corresponding to a contour of a human face.

In other embodiments, the keypad drive member is a rigid grooved rack and the gear assembly includes a pinion that engages the rack. The keypad drive member may be a rotationally flexible member having a first end coupled to the keypad and an opposite second end coupled to the gear assembly that rotates with the gear assembly to linearly move the first end, the flexible member being configured to provide the selected linear movement of the keypad responsive to rotational movement of the second end of the keypad drive member. The gear assembly may include a gear fixedly coupled to the display for rotation therewith. The gear fixedly coupled to the display may be directly coupled to the keypad drive member.

In further embodiments, the gear fixedly coupled to the display is a first gear and the gear assembly further includes a second gear that couples the first gear and the keypad drive member. The first and second gear are configured to provide a gear ratio that provides the selected linear movement of the keypad responsive to rotational movement of the second end of the keypad drive member. The gear assembly may further include a third gear that couples the second gear to the keypad drive member and the second gear may extend between the first gear and the third gear to transmit rotational movement of the first gear to the third gear.

In other embodiments, the coupling mechanism further includes a second gear assembly. The first and second gear assemblies are located in the housing proximate the rotational axis and displaced from each other along the rotational axis. Rotation of the display to the open position extends the display toward the first end and extends the keypad toward the second end.

In yet further embodiments, mobile terminal further includes an activation button coupled to the housing and accessible from outside the housing and a linkage mechanism. The linkage mechanism is between the activation button and the display and is configured to release the display for movement between the closed position and the open position responsive to activation of the activation button. A spring member may be positioned between the linkage mechanism and the display that rotates the display to the open position when released by activation of the activation button. The spring member may be returned to a loaded position by rotation of display from the open position to the closed position. The linkage mechanism may include a latch member that retains the spring member in the loaded position when the display is not released for movement between the closed position and the open position. The activation button may be a pair of buttons on opposite sides of the housing.

In other embodiments, in the open position of the display, the display extends beyond the first end and the keypad extends beyond the second end to provide a mobile terminal having a greater length when the display is in the open position than when the display is in the closed position. The display may not be viewable in the closed position and the mobile terminal may further include a second display coupled to the housing that is viewable when the display is in the closed position.

In yet other embodiments, gear assemblies for a terminal having a display and a keypad include a keypad drive member having a first end configured for connection to the keypad and a gear. The gear is coupled to an opposite second end of the keypad drive member and has a connection point that is configured for connection to the display. The gear is configured to translate rotational movement of the connection point to linear movement of the first end of the keypad drive member. The gear assembly may include the keypad connected to the first end of the keypad drive member and the display connected to the connection point of the gear. The gear assembly may further include a retaining member and a linking mechanism having a first end configured for connection to an activation button and a second end connected to the retaining member, movement of the first end from a rest position to an activated position causing movement of the retaining member from a latch position to a release position.

In further embodiments, methods of changing the configuration of a mobile terminal having a display and a keypad are provided. The display is rotated from a closed position proximate a housing of the mobile terminal to an open position extending from the housing. The keypad is concurrently linearly extended from the housing. Rotating the display may include rotating the display about a rotational axis extending across a width of the housing at a longitudinal position located between and displaced from respective longitudinally displaced first and second ends of the housing and, in the open position, the display may extend beyond the first end of the housing. Concurrently linearly extending the keypad may include extending the keypad beyond the second end of the housing and, after rotating the display and concurrently linearly extending the keypad, the mobile terminal may have an increased overall length and the keypad, housing and display define a curved front face of the mobile terminal generally corresponding to a contour of a human face. Rotating the display and concurrently linearly extending the keypad may be preceded by pressing an activation button on the housing, and rotating the display and concurrently linearly extending the keypad may be automatically performed responsive to pressing of the activation button..

### BRIEF DESCRIPTION OF THE FIGURES

FIG. 1A is a front view of a mobile terminal in a closed position according to some embodiments of the present invention.

FIG. 1B is a front view of the mobile terminal of FIG. 1A in an open position.

FIG. 2 is a back view of the mobile terminal of FIG. 1A in the closed position.

FIG. 3 is a side view of the mobile terminal of FIG. 1A in the open position.

FIG. 4 is an end view of the mobile terminal of FIG. 1A in the closed position.

FIG. 5A is a schematic side view of a mobile terminal in the open position according to some embodiments of the present invention.

FIG. 5B is a schematic side view of a mobile terminal of FIG. 5A in the closed position.

FIG. 6 is a schematic front view of a coupling mechanism for a mobile terminal in an open position according to some embodiments of the present invention.

FIG. 7 is a schematic side view of the coupling mechanism of FIG. 6.

FIG. 8A is a schematic front view of a mobile terminal in an open position according to some embodiments of the present invention.

FIG. 8B is a schematic front view of the mobile terminal of FIG. 8A in a closed position.

FIG. 9 is a schematic front view of the keypad of the mobile terminal of FIG. 8A.

FIG. 10 is a flowchart illustrating a method of changing the configuration of a mobile terminal according to some embodiments of the present invention.

### DETAILED DESCRIPTION OF EMBODIMENTS OF THE INVENTION

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that, although the terms first, second, etc. may be used herein to describe various elements, these elements should not be limited by these terms. These terms are only used to distinguish one element from another.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

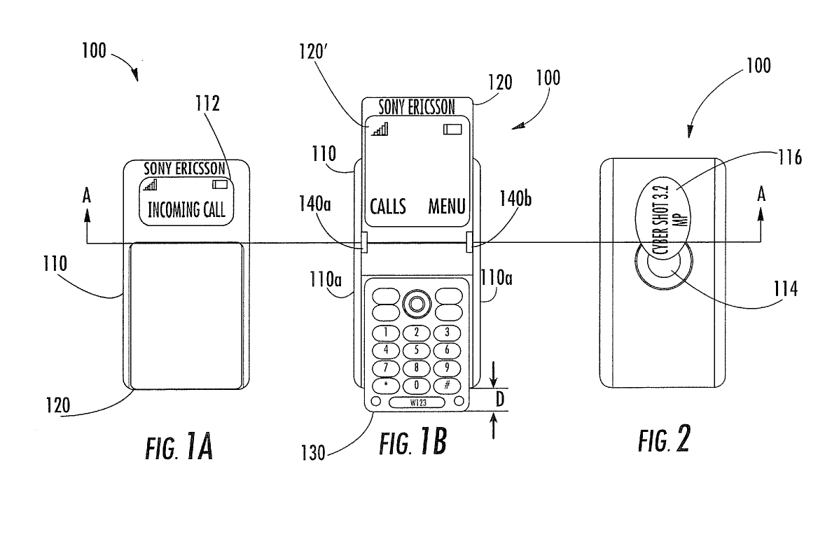

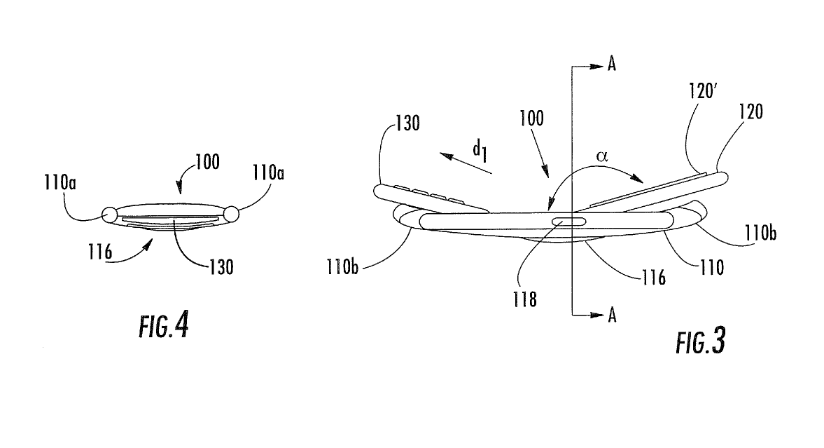

A mobile terminal according to some embodiments of the present invention will now be described with reference to FIGS. 1A to 4. FIG. 1A is front view of a mobile terminal 100 in a closed position. FIG. 1B is a front view of the mobile terminal 100 in an open position. FIG. 2 is a back view of the mobile terminal 100 in the closed position. FIG. 3 is a side view of the mobile terminal 100 in the open position. FIG. 4 is an end view of the mobile terminal 100 in the closed position.

As seen in FIGS. 1A and 1B, the mobile terminal 100 includes a portable housing 110, a display 120 and a keypad 130. The display 120 includes a graphical display area 120′ that is viewable in the open position shown in FIG. 1B and hidden in the closed position shown in FIG. 1A for the illustrated embodiments of FIGS. 1A and 1B. The housing 110 includes a second display 112 fixed therein that is viewable when the display 120 is in the closed position shown in FIG. 1A.

The display 120 is rotatably coupled to the housing 110 for movement between a closed position proximate the housing 110 as shown in FIG. 1A to an open position extending from the housing 110 as shown in FIG. 1B and FIG. 3. Similarly, as seen in FIG. 1B, the keypad 130 is movably coupled to the housing 110. More particularly, rotation of the display 120 to the open position of FIG. 1B extends the display 120 beyond a first end of the housing 1 10 and linear displacement of the keypad 130 extends the keypad 130 beyond the opposite second end of the housing 110.

FIGS. 1A, 1B and 2 are arranged along a reference line AA that corresponds to the location of the rotational axis of the display 120. As seen in FIG. 1B, the rotational axis AA of the display 120 extends between respective sides 110a of the housing 110, where the distance between the sides 110a will be referred to herein as a width of the mobile terminal 100 and a longitudinal axis extending between the first and second ends of the housing 110 will be referred to as the length of the mobile terminal 100. Thus, as seen in the comparison of FIG. 1A to FIG. 1B, the length of the mobile terminal 100 is extended by movement of the display 120 and the keypad 130 between the closed and open positions.

As illustrated in FIG. 1B, the display 120 may be provided with two hinges 140a, 140b. The hinges 140a, 140b are displaced along the axis AA on opposite sides of the housing 110 and the display 120 is rotationally coupled to the housing 110 by the respective hinges 140a, 140b.

Referring to FIG. 2, the illustrated mobile terminal 100 further includes a camera 114 and a slidable camera cover 116. As also seen in FIG. 4, the sides 110A of the housing 110 may be rounded, which may provide for a more comfortable feel to a user holding the mobile terminal 100.

Referring now to FIG. 3, an activation button 118 may be provided. More particularly, in the embodiments of FIG. 3, a pair of activation buttons 118 (one shown in FIG. 3) may be provided generally aligned to the rotational axis AA on opposite sides 110a of the housing 110. A linkage mechanism may be provided between the activation button(s) 118 and the display 120 that is configured to release the display 120 for a movement between the closed position of FIG. 1A and the open position seen in FIG. 3 responsive to activation of the activation button(s) 118. In some embodiments, a spring member may be positioned between the linkage mechanism and the display 120 that rotates the display 120 to the open position when released by activation of the activation button(s) 118. The spring member may be returned to a loaded position by rotation of the display 120 from the open position to the closed position. More particularly, the linkage mechanism may include a latch member that retains the spring member in the loaded position when the display 120 is not released from movement between the closed position and the open position.

As further seen in FIG. 3, the keypad 130, housing 110, and display 120 define a curved front face of the mobile terminal 100 generally corresponding to a contour of a human face. The back face, in some embodiments, may be curved to conform comfortably to a human hand. As shown in FIG. 3, the display 120 moves α degrees to transition from a closed to the open position. Furthermore, the keypad extends linearly in a direction d₁ chosen to define an angle of the lower end of the contour front face shape. Note that the use of oppositely situated pair of activation buttons 118 may facilitate ease of one hand operation of the mobile terminal 100.

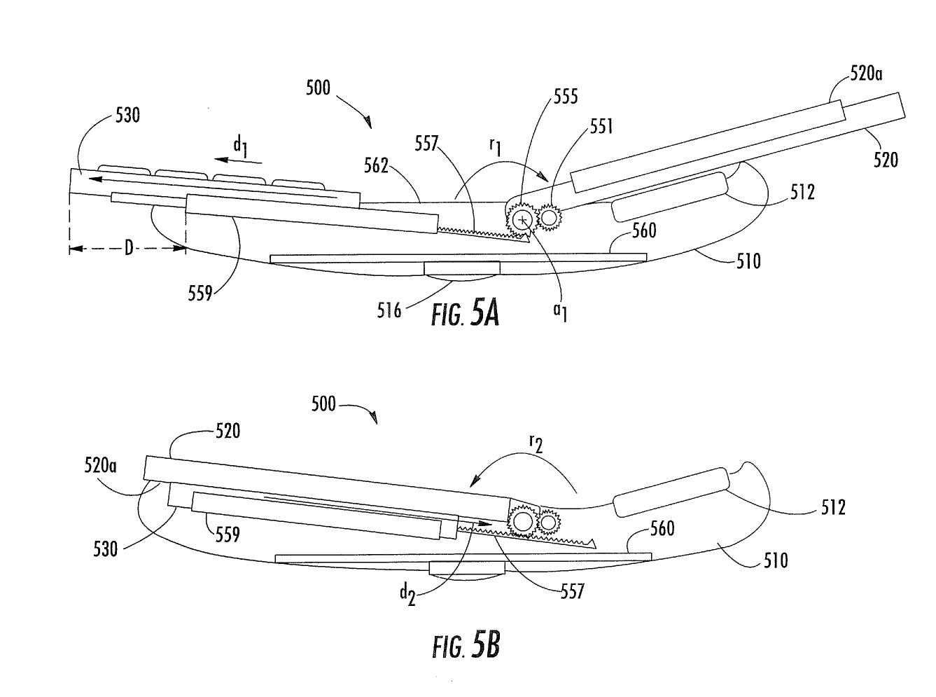

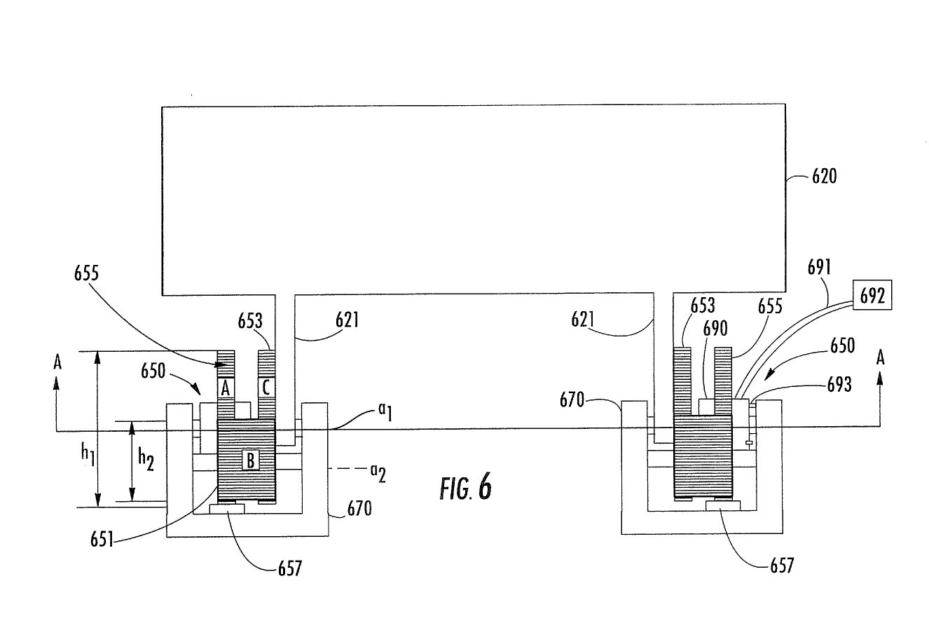

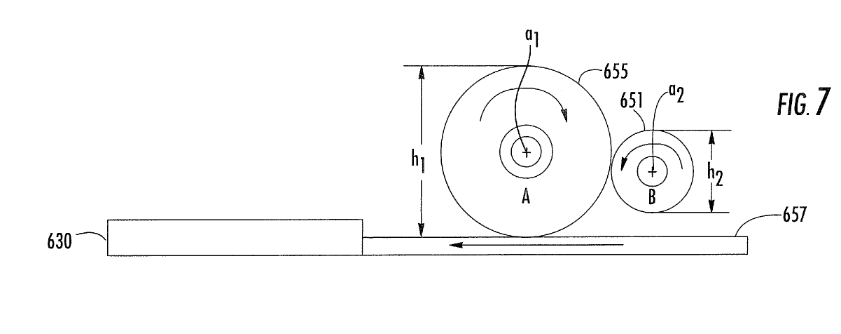

As will further be described herein with reference to FIGS. 5A and 5B, the display 120 and keypad 130 move concurrently upon activation. Similarly, movement of the display 120 to the closed position may concurrently pull the keypad 130 back in from its linearly extended position. Such an arrangement may be provided by using a coupling mechanism coupled to the display 120 and the keypad 130 that translates rotational movement of the display 120 between the open and closed position to a selected displacement of the keypad 130 which will now be further described with reference to FIGS. 5A and 5B.

FIG. 5A is a schematic side view of a mobile terminal 500 in an open position according to some embodiments of the present invention. FIG. 5B is a schematic side view of the mobile terminal 500 in the closed position. The housing of the mobile terminal 500 is not shown to allow viewing of internal components defining a coupling mechanism therein. However, an outline representation of the housing 510 is shown in FIGS. 5A and 5B for reference purposes.

As seen in FIGS. 5A and 5B, the display 520 is rotatably coupled to the housing 510 and the keypad 530 is movably coupled to the housing 510. The display 520 moves on a rotational path r₁ while the keypad 530 extends to the open position by linear movement in a direction d₁ and returns in a direction d₂ to the closed position of FIG. 5B. A housing section 562 may be provided so that a user does not see the operative mechanism of the terminal 500 when the terminal 500 is in the open position shown in FIG. 5A.

A display area 520a is shown provided on the display 520. Display area 520a is viewable in the open position of FIG. 5A but not in the closed position shown in FIG. 5B. A second display 512 is shown mounted to the housing 510 that is covered by the display 520 in the open position and viewable in the closed position of FIG. 5B when the display area at 520a is not viewable. Thus, information may be displayed to a user in the closed position on display 512 while the display area at 520a may be used in the open position shown in FIG. 5A. However, it will be understood that, in some embodiments, all or a portion of the main display area 520a is visible in the closed position of FIG. 5B and the second display 512 maybe omitted.

Also shown in FIGS. 5A and 5B is a printed circuit board (PCB) 560 including a communications circuit. Such a communication circuit may be used for local area network support and/or cellular network interfacing and/or the like. A camera may further be mounted on the PCB 560, viewing towards a back face of the housing 510. A camera cover 516 may be movably coupled to the back face of the housing 510 to protect a lens of the camera when not in use.

A coupling mechanism coupling the display 520 to the keypad 530 is also shown in the embodiments of FIGS. 5A and 5B. More particularly, the coupling mechanism, as illustrated in FIGS. 5A and 5B, may include a keypad drive member 557 coupled to the keypad 530 and a gear assembly 551, 555 coupling the keypad drive member 557 to the display 520. More particularly, the gear assembly 551, 555 may be arranged to provide a coupling that translates rotational movement of the display 520 to selected linear movement of the keypad 530.

In the particular embodiments of FIGS. 5A and 5B, the keypad drive member 557 comprises a rigid grooved rack 557 and the gear assembly includes a pinion 555 that engages the rack 557. However, it will be understood that the keypad drive member 557 may include a rotationally flexible member having a first end coupled to the keypad 530 and an opposite second end coupled to gear assembly 551, 555 that rotates with the gear assembly to linearly move the end coupled to the keypad assembly 530. In such a case, rather than extend beyond the gear assembly as shown in FIG. 5B, the keypad drive member 557 may have an end that rotates with the pinion of 555 and does not extend further in the housing 510. When the keypad drive member 557 is a flexible member, the flexible member may be configured to provide the selected linear movement of the keypad 530 responsive to rotational movement of the second end of the keypad drive member 557. For example, a width of the flexible drive member 557 and stiffness of the selected material may be selected such that rotation about the pinion 555 may be provided without buckling of the keypad drive member 557 or twisting thereof, which could reduce the repeatably of the linear motion imparted to the keypad 530.

Also shown in the embodiments of FIGS. 5A and 5B is a keypad guiderail 559. The keypad guiderail 559 may be provided to facilitate desired linear displacement of the keypad 530 by limiting the ability of the keypad 530 to skew gearing linear displacement or the like.

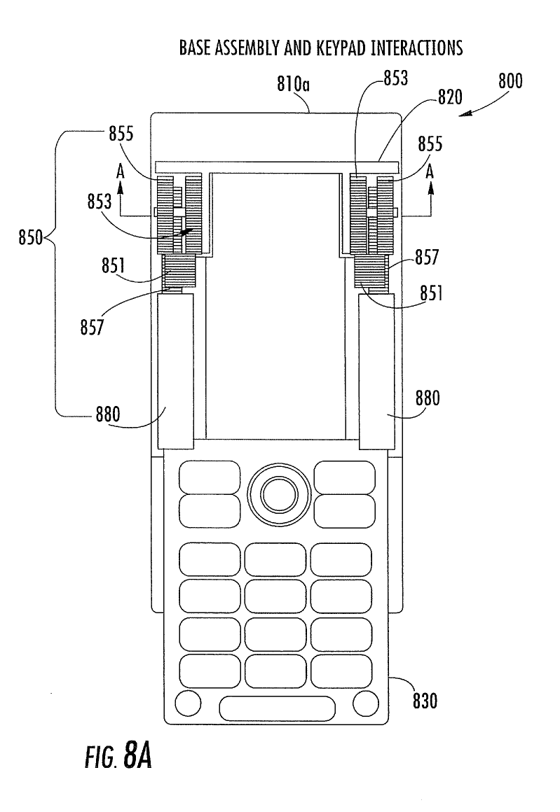

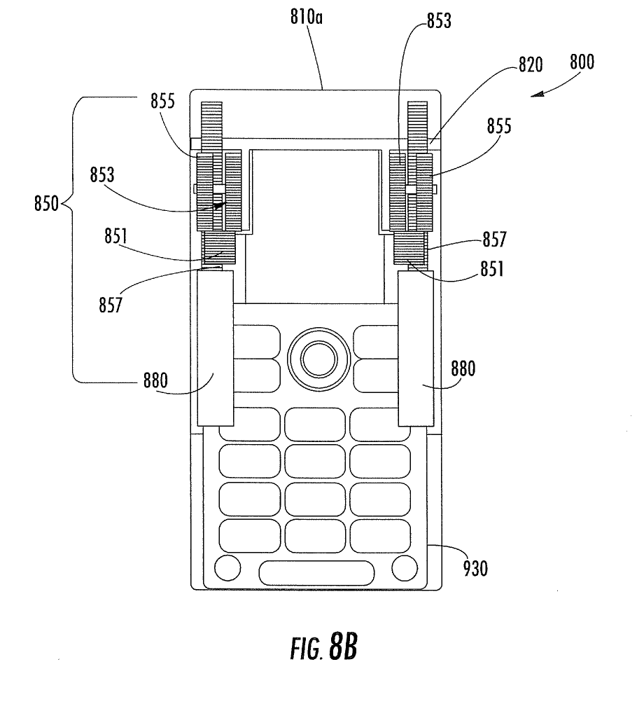

Further embodiments of the present invention will now be described with reference to FIGS. 6 and 7. FIG. 6 is a schematic front view of a coupling mechanism for a mobile terminal in an open position according to some embodiments of the present invention. FIG. 7 is a schematic side view of the coupling mechanism of FIG. 6.

As shown in the embodiments of FIGS. 6 and 7, a rotatable display 620 includes hinge arms 621 extending to respective first and second gear assemblies 650. Each gear assembly 650 includes a gear C 653 fixedly coupled to the hinge arm 621 for rotational movement with the display 620. As will be described herein, the gear C 653 is coupled to a keypad drive member 657 that is coupled to a keypad 630. The gear assembly 650 translates rotational movement of the display 620 to a selected linear movement of the keypad 630 through the keypad drive member 657.

While the gear C 653 may be directly coupled to the keypad drive member 657, additional gears are shown in the illustrated embodiments of FIGS. 6 and 7 to provide a gear ratio that provides the selected linear movement of the keypad responsive to a set rotational movement of the display 620. More particularly, as shown in the embodiments of FIGS. 6 and 7, when the gear C 653 rotates it drives a second gear B 651. The second gear B 651 extends between the first gear C 653 and a third gear A 655 that is an engagement with the keypad drive member 657 to transmit the rotational movement of the first gear C 653 to the third gear A 655 to drive the keypad drive member 657. Note that the gear A 655 and gear C 653 both rotate about the axis a, corresponding to the rotational axis of the display 620, while gear B 651 rotates about an axis a₂ displaced therefrom. Both gear A 655 and gear C 653 may have a same height h₁ and gear B 651 may have a height h₂. However, it will be understood that gears A and C may be given different heights/diameters to provide a desired gear ratio. In addition, it will be understood that more than three gears may be used in the gear assembly or that the translation be provided without the use of a gear assembly.

Each gear assembly 650 may include a housing 670 providing support for the respective gears and defining the respective rotational axis. In addition, a latch 690 may be provided that is part of a linkage mechanism 691 extending to an activation button 692. As discussed with reference to the activation button 118, the activation button 692, shown symbolically in FIG. 6, may cooperate with the linkage mechanism 691 to release the display 620 for movement between the closed position and the open position responsive to activation of the activation button 692. A spring member 693 may be positioned between the linkage mechanism 691 and the display 620 that rotates the display 620 to the open position when released by activation of the activation button. More particularly, the latch member 690 may retain the spring member 693 in the loaded position when the display 620 is not released for movement between the closed position and the open position.

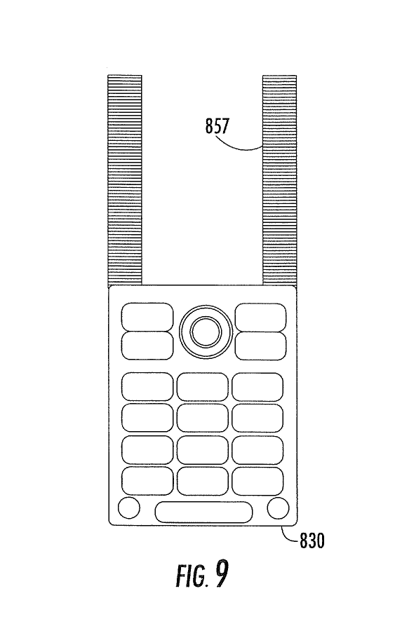

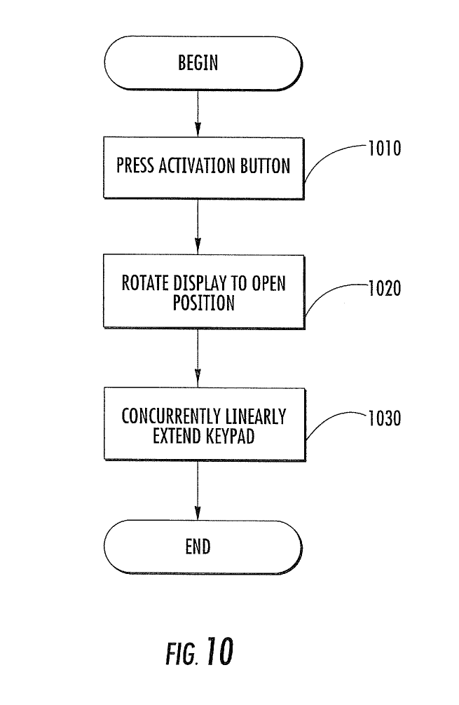

Further embodiments of the present invention will now be described with reference to Figures SA, 8B and 9. Figure SA is a schematic front view of a mobile terminal 800 in an open position according to some embodiments of the present invention. FIG. 8B is a schematic front view of the mobile terminal 800 in a closed position. FIG. 9A is a schematic front view of the keypad of the mobile terminal 800 of FIGS. 8A and 8B.

As shown in the embodiments of FIGS. 8A and 8B, the mobile terminal 800 may include a housing 810a (note only a portion of the housing is shown for illustrative purposes in FIGS. 8A and 8B) and a flip assembly 820 coupled rotationally to the housing 810A. Note that the flip assembly 820 includes a display area and is shown only schematically in FIG. 8A.

A linearly displaceable keypad 830 is also shown in FIG. 8A and FIG. 9. A pair of keypad drive members 857 extend from the keypad 830. Linear displacement of the keypad 830 is constrained by a pair of guardrails 880 as seen in FIG. 8A.

Also shown in FIG. 8A is a coupling mechanism coupled to the display 820 and the keypad 830 that translates rotational movement of the display (flip) 820 between the open and closed position to a selected displacement of the keypad 830. More particularly, the coupling mechanism includes a pair of gear assemblies 850 coupling the keypad drive member 857 to the display 820 that translate rotational movement of the display 820 to the selected linear movement of the keypad 830. As seen in FIG. 8A, each gear assembly 850 includes three gears 851, 853, 955 that operate substantially as described with reference to the gear assembly 650 of FIGS. 6 and 7. Accordingly, further details of the operation of the gear assemblies 850 need not be provided herein.

Methods of changing the configuration of a mobile terminal having a display and a keypad according to some embodiments of the present invention will now be described with reference to FIG. 10. As shown in FIG. 10, operations begin by pressing an activation button on the housing of the mobile terminal (block 1010). Responsive to activation of the activation button, the display rotates from a closed position, proximate the housing of the mobile terminal, to an open position extending from the housing (block 1020). Concurrently with rotation of the display, the keypad of the housing is linearly extended from the housing (block 1030). The display may be rotated about a rotational axis extending across a width of the housing at a longitudinal position located between and displaced from respective longitudinally displaced first and second ends of the housing. In other words, unlike conventional flip phonies, the axis of rotation for the flip (display) is not at an end of the housing in such embodiments. In addition, in the open position, the display may be extended beyond the first end of the housing while the keypad may be concurrently extended beyond the opposite second end of the housing. As a result of these motions, the terminal may be provided an increased overall length and the keypad, housing and display may define a curved front face of the mobile terminal generally corresponding to a contour of a human face.

As described above, some embodiments of the present invention provide a clam shell (flip) style mobile terminal (cell phone) that can be completely operated with one hand by a user. The phone may have a unique feel and may be small and compact while providing excellent features in an elegant design, which design may be particularly usefully combined with integrated camera technology in a versatile portable hand-held user device. Both opening and closing operations for the terminal may be performed with a hand and opening the phone may be achieved by simultaneously selecting, for example, a pair of buttons on the sides of the phone to activate opening.

Once selected, the flip containing the display area may rotate upward from a center of the phone and push a keypad of the phone in an outward direction. Such motions may be configured to provide a desired contour to a front face of the phone during use while the bottom face of the phone may be provided a distinct contour therefrom. Thus, a front face may be matched to the contour of the human face and a bottom may be matched to the contour of a human hand in some embodiments.

The keypad may slide in and out from a closed position on a set of tracks and the buttons on the sides of the phone may serve to both lock and unlock the flip/keypad components. To close the phone, the user may simply press the flip cover inward and the keypad will be returned back to its original position by the flip movement. In addition, the flip movement may provide for loading of a spring in embodiments where automated extension of the flip in keypad from the closed to the open position is desired. The lengthening of the phone in the open position due to the extension of the flip and the sliding keypad may make the phone feel bigger and more comfortable to use as it may reduce the sense of smallness of a cellular phone that is considered undesirable by some users.

The exterior of the cellular phone may be provided with curved surfaces to avoid sharp edges and rectangular shapes and provided a limited number of buttons to provide basic functionality without creating user confusion. A camera may be hidden/protected with a smooth sliding cover on the phone exterior. The buttons themselves may be slightly recessed into the smooth surface of the terminal housing. The hinges, sliding mechanism and other operative portions may be blocked from user view inside the housing of the cell phone. Thus, an exterior appearance may be provided in some embodiments that appears like a bar/stick phone but operates as a clam/flip phone.

A gear ratio may be designed into the gear assembly to provide flexibility in selection of the linear displacement of the keypad provided by a desired rotational movement of the display flip assembly. For example, with reference to the gears A, B and C, 655, 651, 653 of FIGS. 6 and 7, the translational relationships maybe expressed as follows:

Travel (D)=Circumference gear A (Ca)/Gear ratio total (GRT)

Ca=πD=21.4 mm

Grt=1:1 (A to C)

D=21.4 mm/1 or 21.4 mm

Flip movement between 120 deg and 180 deg Using 120 deg. Or ⅓ rotation the D=⅓×21.4 mm Or ˜7.2 mm

In the drawings and specification, there have been disclosed embodiments of the invention and, although specific terms are employed, they are used in a generic and descriptive sense only and not for purposes of limitation, the scope of the invention being set forth in the following claims.

That which is claimed is:

1. A mobile terminal, comprising:
a portable housing;
a display rotatably coupled to the portable housing for movement between a closed position proximate the housing to an open position extending from the housing;
a keypad moveably coupled to the portable housing; and
a coupling mechanism coupled to the display and to the keypad that translates rotational movement of the display between the open and closed position to a selected displacement of the keypad.

2. The mobile terminal of claim 1, wherein the selected displacement comprises a selected linear movement and wherein the coupling mechanism comprises:
a keypad drive member coupled to the keypad; and
a gear assembly coupling the keypad drive member to the display that translates rotational movement of the display to the selected linear movement of the keypad.

3. The mobile terminal of claim 2, wherein the display is rotatably coupled to the housing about a rotational axis extending across a width of the housing and wherein rotation of the display to the open position extends the display toward the first end and extends the keypad toward the second end.

4. The mobile terminal of claim 3, wherein the rotational axis extends across the width of the housing at a longitudinal position located between and displaced from respective longitudinally displaced first and second ends of the housing.

5. The mobile terminal of claim 4, further comprising a wireless communication circuit in the housing and wherein the housing comprises a handheld housing and wherein, when the display is in the open position, the keypad, housing and display define a curved front face of the mobile terminal generally corresponding to a contour of a human face.

6. The mobile terminal of claim 3, wherein the keypad drive member comprises a rigid grooved rack and the gear assembly includes a pinion that engages the rack.

7. The mobile terminal of claim 3, wherein the keypad drive member comprises a rotationally flexible member having a first end coupled to the keypad and an opposite second end coupled to the gear assembly that rotates with the gear assembly to linearly move the first end, the flexible member being configured to provide the selected linear movement of the keypad responsive to rotational movement of the second end of the keypad drive member.

8. The mobile terminal of claim 3, wherein the gear assembly includes a gear fixedly coupled to the display for rotation therewith.

9. The mobile terminal of claim 8, wherein the gear fixedly coupled to the display is directly coupled to the keypad drive member.

10. The mobile terminal of claim 8, wherein the gear fixedly coupled to the display comprises a first gear and wherein the gear assembly further comprises a second gear that couples the first gear and the keypad drive member, the first and second gear being configured to provide a gear ratio that provides the selected linear movement of the keypad responsive to rotational movement of the second end of the keypad drive member.

11. The mobile terminal of claim 10, wherein the gear assembly further comprises a third gear that couples the second gear to the keypad drive member and wherein the second gear extends between the first gear and the third gear to transmit rotational movement of the first gear to the third gear.

12. The mobile terminal of claim 3, wherein the gear assembly comprises a first gear assembly and wherein the coupling mechanism further comprises a second gear assembly, the first and second gear assemblies being located in the housing proximate the rotational axis and displaced from each other along the rotational axis and wherein rotation of the display to the open position extends the display toward the first end and extends the keypad toward the second end.

13. The mobile terminal of claim 3, wherein mobile terminal further comprises:
an activation button coupled to the housing and accessible from outside the housing; and
a linkage mechanism between the activation button and the display that is configured to release the display for movement between the closed position and the open position responsive to activation of the activation button.

14. The mobile terminal of claim 13, further comprising a spring member positioned between the linkage mechanism and the display that rotates the display to the open position when released by activation of the activation button, the spring member being returned to a loaded position by rotation of display from the open position to the closed position and wherein the linkage mechanism includes a latch member that retains the spring member in the loaded position when the display is not released for movement between the closed position and the open position.

15. The mobile terminal of claim 14, wherein the activation button comprises a pair of buttons on opposite sides of the housing.

16. The mobile terminal of claim 3, wherein, in the open position of the display, the display extends beyond the first end and the keypad extends beyond the second end to provide a mobile terminal having a greater length when the display is in the open position than when the display is in the closed position.

17. The mobile terminal of claim 3, wherein the display is not viewable in the closed position and wherein the mobile terminal further comprises a second display coupled to the housing that is viewable when the display is in the closed position.

18. A gear assembly for a terminal having a display and a keypad, comprising:
a keypad drive member having a first end configured for connection to the keypad;
a gear coupled to an opposite second end of the keypad drive member and having a connection point that is configured for connection to the display, the gear being configured to translate rotational movement of the connection point to linear movement of the first end of the keypad drive member.

19. The gear assembly of claim 18, further comprising:
the keypad connected to the first end of the keypad drive member; and
the display connected to the connection point of the gear.

20. The gear assembly of claim 19, wherein the gear assembly further includes a retaining member and wherein the gear assembly further comprises a linking mechanism having a first end configured for connection to an activation button and a second end connected to the retaining member, movement of the first end from a rest position to an activated position causing movement of the retaining member from a latch position to a release position.

21. A method changing the configuration of a mobile terminal having a display and a keypad, the method comprising:
rotating the display from a closed position proximate a housing of the mobile terminal to an open position extending from the housing; and
concurrently linearly extending the keypad from the housing.

22. The method of claim 21, wherein rotating the display comprises rotating the display about a rotational axis extending across a width of the housing at a longitudinal position located between and displaced from respective longitudinally displaced first and second ends of the housing and wherein, in the open position, the display extends beyond the first end of the housing.

23. The method of claim 22, wherein concurrently linearly extending the keypad includes extending the keypad beyond the second end of the housing and wherein, after rotating the display and concurrently linearly extending the keypad, the mobile terminal has an increased overall length and the keypad, housing and display define a curved front face of the mobile terminal generally corresponding to a contour of a human face.

24. The method of claim 22, wherein rotating the display and concurrently linearly extending the keypad are preceded by pressing an activation button on the housing, and wherein rotating the display and concurrently linearly extending the keypad are automatically performed responsive to pressing of the activation button.
